(19) United States
(12) Patent Application Publication
(10) Pub. No.: US 2014/0365946 A1
(43) Pub. Date: Dec. 11, 2014

(54) SYSTEMS AND METHODS FOR OPERATING AND MANAGING ENTERPRISE SYSTEMS ON A MOBILE ELECTRONIC DEVICE

(71) Applicants: Pugazhenthi Sankaralingham, Duluth, GA (US); Mohamed Reyaz, Marietta, GA (US)

(72) Inventors: Pugazhenthi Sankaralingham, Duluth, GA (US); Mohamed Reyaz, Marietta, GA (US)

(21) Appl. No.: 14/293,313

(22) Filed: Jun. 2, 2014

Related U.S. Application Data
(60) Provisional application No. 61/833,358, filed on Jun. 10, 2013.

(51) Int. Cl. G06F 3/0488

(52) U.S. Cl. CPC G06F 3/04886
USPC 715/773

(57) ABSTRACT

The present disclosure provides methods and apparatuses operable to manage an enterprise system via a mobile electronic device. The mobile electronic device includes a touch screen display, a transmitter configured for bi-directional wireless communication, and a processor configured to provide a user interface to the mobile electronic device, wherein the mobile electronic device connects, via the transmitter, to at least one computer system remote from the mobile electronic device, the processor further configured to cause display of a soft-overlay keyboard on the touch screen display, wherein the soft-overlay keyboard is superimposed on content displayed on the touch screen display. The mobile electronic device further includes a harness removably coupled to the mobile electronic device.

### CROSS-REFERENCE TO RELATED APPLICATION

The present application claims priority to U.S. Provisional Patent Application No. 61/833,358, filed Jun. 10, 2013 and entitled “SYSTEMS AND METHODS FOR OPERATING AND MANAGING ENTERPRISE SYSTEMS ON A MOBILE ELECTRONIC DEVICE,” which application is incorporated herein by reference in its entirety.

### TECHNICAL FIELD

The present application relates generally to the field of enterprise systems. More specifically, the present application relates to systems for remotely controlling and managing enterprise systems for inventory management.

### BACKGROUND

Warehouse, distribution center, and fulfillment center operators use wearable computers to perform tasks within their operations. These wearable computers are generally worn by operators in the arms or hips while performing operations like loading, unloading, picking, location inventory. These wearable computers provide mobility to operators while simultaneously providing real-time connectivity with inventory control systems for increasing the accuracy and efficiency of their operations. However, these wearable computers have disadvantages associated with their weight, and user interface. Additionally, these devices lack adaptability and configurability across a variety of platforms and back end systems making them expensive to purchase and upgrade or use across multiple industries.

The inventory in warehouses, distribution centers, and fulfillment centers has financial value and is reflected as an assent in the firm's balance sheet. The accuracy of the inventory level is very critical for the firm carrying the inventory as it impacts the order fill rate of the firm and revenue. For at least these reasons, warehouse operators routinely count inventory in locations using wearable computer devices to track the manually counted inventory in a location. This inventory count takes valuable labor out of receiving and shipping operations in the warehouse and makes inventory management, onerous, labor intensive, inefficient, and at times unreliable.

Additionally, warehouse managers are tasked with managing their labor efficiently and reducing unproductive labor time. Labor management systems are used to calculate operator productivity, which may be used to incentivize highly productive operators. The amount of distance user travels within the warehouse as part of their operations is a major factor in determining operator productivity. The current labor management systems face difficult challenges related to accurately locating a user in the warehouse and calculating the distance a user travelled. Current systems use the X, Y, and Z coordinates tied to the locations scanned by the user to calculate the distance travelled. Often users scan locations before they even physically arrive at the location to boost their productivity and game the system.

### SUMMARY

The inventors have appreciated that implementation of inventive applications on readily available consumer products provides lightweight, reliable, and easily configurable systems for a variety of enterprise applications. Additionally, these systems may be implemented in inventive ways to increase efficiency and accuracy of inventory management and labor management. In view of the foregoing, the present disclosure is directed to methods and apparatuses operable to provide terminal emulation on mobile electronic devices, inventory management via mobile electronic devices, and labor management via mobile electronic devices.

An exemplary inventive embodiment provides a mobile electronic device for terminal emulation. The mobile electronic device includes a touch screen display, a transmitter configured for bi-directional wireless communication, and a processor configured to provide a user interface to the mobile electronic device, wherein the mobile electronic device connects, via the transmitter, to at least one computer system remote from the mobile electronic device, the processor further configured to cause display of a soft-overlay keyboard on the touch screen display, wherein the soft-overlay keyboard is superimposed on content displayed on the touch screen display. The mobile electronic device further includes a harness removably coupled to the mobile electronic device.

In various embodiments the user interface includes at least one of a telnet, a ssh, a http and a https user interface.

The mobile electronic device may include an image capture device. The mobile electronic device may include a video capture device. In accordance with various embodiments the processor is further configured to upload at least one of an image obtained by the image capture device to a transfer protocol server.

A scanner may be coupled to the mobile electronic device. The scanner may include a bar code scanner. The scanner may include a ring scanner.

In various embodiments, the at least one computer system includes an inventory management system.

The soft-overlay keyboard may include at least one of an alpha, numeric, function and cursor key keyboard in accordance with various embodiments.

The keys of soft-overlay keyboard may be configured in response to a selected function.

In various embodiments the mobile electronic device includes an RFID reader.

An exemplary inventive embodiment provides a method for emulating a terminal on a mobile electronic device. The method includes providing a user interface to the mobile electronic device, whereby the mobile electronic device is configured for wirelessly connecting to at least one computer system. The method further includes causing, on a touch screen display of the mobile electronic device, via at least one processor of the mobile electronic device, a display of a soft-overlay keyboard on the touch screen display, wherein the soft-overlay keyboard is superimposed on content displayed on the touch screen display.

The user interface may include at least one of a telnet, a ssh, a http and a https user interface in accordance with various embodiments.

In various embodiments, the method includes configuring, via the at least processor, a connection protocol for wirelessly connecting to the at least one computer.

The method may include reading, via the at least one processor, at least one return parameter transmitted from the at least one computer to the mobile electronic device.

In various embodiments, the method includes electronically coupling the mobile electronic device with a barcode scanner.

Another exemplary inventive embodiment provides a system for emulating a terminal on a mobile electronic device. The system includes a user interface engine configured to wirelessly connect the mobile electronic device to at least one computer system. The system also includes a soft-overlay keyboard generator configured to cause on a touch screen display of the mobile electronic device, via at least one processor of the mobile electronic device, a display of a soft-overlay keyboard on the touch screen display, wherein the soft-overlay keyboard is superimposed on content displayed on the touch screen display.

In various embodiments, the user interface engine is configured to wirelessly connect the mobile electronic device to at least one computer system via at least one of a telnet, a ssh, a http, and a https.

The system may include an RFID reader, wherein the RFID reader configured to transmit a message to the at least one computer system in response to receipt of a detected RFID signal.

The system may include a monitoring module configured to store device handling information. The monitoring module may store the location of the device based on GPS data. The monitoring module may store information in response to activation of the telnet user interface.

Another exemplary inventive embodiment provides a system for configuring a mobile device for enterprise use. The system includes an application disabling engine. The application disabling engine is configured to disable one or more applications running on the device, the one or more application selected from the group consisting of an internet browser, a gaming application and a music player. The system also includes an installer configured to download an enterprise application on the mobile device. The enterprise application includes a user interface engine configured to wirelessly connect the mobile electronic device to at least one computer system, and a soft-overlay keyboard generator configured to cause on a touch screen display of the mobile electronic device, via at least one processor of the mobile electronic device, a display of a soft-overlay keyboard on the touch screen display, wherein the soft-overlay keyboard is superimposed on content displayed on the touch screen display. The system also includes an identification requester configured to obtain a user identification and a user password. The system further includes an application restrictor, the application restrictor configured to restrict at least one communication application installed on the device to operation with at least one user from a pre-defined user group.

The user interface engine of the system may be configured to wirelessly connect the mobile electronic device to at least one computer system via at least one of a telnet, a ssh, a http, and a https.

One exemplary inventive embodiment provides an inventory management system. The inventory management system includes a user interface engine configured to wirelessly connect a mobile electronic device to at least one computer system, a soft-overlay keyboard generator configured to cause on a touch screen display of the mobile electronic device, via at least one processor of the mobile electronic device, a display of a soft-overlay keyboard on the touch screen display, wherein the soft-overlay keyboard is superimposed on content displayed on the touch screen display, and an image retriever, configured to facilitate selection of an inventory item from an inventory image database and cause display of an image of a selected inventory item on the touch screen display.

In accordance with various embodiments of the inventory management system, the user interface engine is configured to wirelessly connect the mobile electronic device to at least one computer system via at least one of a telnet, a ssh, a http, and a https.

Another exemplary inventive embodiment provides a voice enabled inventory management system. The system includes a user interface engine configured to wirelessly connect a mobile electronic device to at least one computer system. The system also includes a soft-overlay keyboard generator configured to cause on a touch screen display of the mobile electronic device, via at least one processor of the mobile electronic device, a display of a soft-overlay keyboard on the touch screen display, wherein the soft-overlay keyboard is superimposed on content displayed on the touch screen display. The system further includes a voice interface controller configured to convert commands received from the at least one computer system to voice prompts, the voice prompts transmitted via an audio component of the mobile electronic device, the voice interface controller further configured to obtain voice commands via a microphone component of the mobile electronic device and convert the voice commands to text for transmission to the at least one computer system via the telnet user interface.

The user interface engine of the voice enabled inventory management may be configured to wirelessly connect the mobile electronic device to at least one computer system via at least one of a telnet, a ssh, a http, and a https.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawing primarily is for illustrative purposes and is not intended to limit the scope of the inventive subject matter described herein. The drawing is not necessarily to scale; in some instances, various aspects of the inventive subject matter disclosed herein may be shown exaggerated or enlarged in the drawings to facilitate an understanding of different features. In the drawing, like reference characters generally refer to like features (e.g., functionally similar and/or structurally similar elements).

FIG. 1 is a diagram illustrating a terminal emulation system in accordance with exemplary inventive embodiments.

FIG. 2 shows a mobile electronic device for implementing the terminal emulation system of FIG. 1.

FIG. 3 illustrates another mobile electronic device embodiment for implementing the terminal emulation system of FIG. 1

FIGS. 4A-4C illustrate a wearable sleeve for holding a mobile electronic device implemented for terminal emulation on an operators arm in accordance with exemplary inventive embodiments.

FIG. 5 shows a case for increasing impact resistance and durability of a mobile electronic device implemented for terminal emulation in accordance with exemplary inventive embodiments.

FIG. 6A illustrates a display of a device, such as an iPod touch, having a terminal emulation application in accordance with exemplary inventive embodiments installed thereon.

FIG. 6B provides a screen shot of an initiation screen displayed on a mobile device at the start of a terminal emulation session in accordance with exemplary inventive embodiments.

FIGS. 7A and 7B show screen shots of the connection screens displayed on a mobile device at the start of a terminal emulation session in accordance with exemplary inventive embodiments.

FIG. 8 illustrates a screen shot of the emulated terminal as displayed on the mobile device upon connection to a remote computer terminal in accordance with exemplary inventive embodiments.

FIGS. 9A-9I illustrate screen shots of various configuration parameters selectable via a mobile electronic device in connection with connecting to a remote computer terminal in accordance with exemplary inventive embodiments.

FIGS. 10A-10D show screen shots of various settings selectable via a mobile electronic device in connection with connecting to a remote computer terminal in accordance with exemplary inventive embodiments.

FIG. 11A-11C illustrates a screen shot of a mobile device operable to disconnect from a remote computer terminal in accordance with exemplary inventive embodiments.

FIG. 12 illustrates a soft-overlay cursor keyboard displayable on a mobile device in connection with connecting the mobile device to a remote computer terminal in accordance with exemplary inventive embodiments.

FIG. 13 illustrates a soft-overlay alpha keyboard displayable on a mobile device in connection with connecting the mobile device to a remote computer terminal in accordance with exemplary inventive embodiments.

FIG. 14 illustrates a soft-overlay function keyboard displayable on a mobile device in connection with connecting the mobile device to a remote computer terminal in accordance with exemplary inventive embodiments.

FIG. 15 illustrates a soft-overlay numeric keyboard displayable on a mobile device in connection with connecting the mobile device to a remote computer terminal in accordance with exemplary inventive embodiments.

FIG. 16A illustrates a QWERTY keyboard of a mobile device being displayed during a terminal emulation session on the mobile device to a remote computer terminal in accordance with exemplary inventive embodiments.

FIGS. 16B-16F illustrate a personal keyboard configurable and displayed during a terminal emulation session on the mobile device in accordance with exemplary inventive embodiments.

FIGS. 17A-17E depict screen shots of uploader system transitioning through various processes in accordance with exemplary inventive embodiments.

FIG. 18 provides a flow diagram for inventory count by image system in accordance with exemplary inventive embodiments.

FIGS. 19A-19C provides a schematic diagram of an inventory count by image system in accordance with exemplary inventive embodiments.

FIG. 20 provides a screen shot of a labor management system implemented in accordance exemplary inventive embodiments.

FIGS. 21-22 provides a screen shot of an uploader application implemented in accordance exemplary inventive embodments.

FIG. 23 illustrates a management console application that may be used to configure the other application disclosed herein in accordance exemplary inventive embodiments.

FIGS. 24A-24K illustrate screenshots of the management console application of FIG. 23 in accordance exemplary inventive embodiments.

The features and advantages of the inventive concepts disclosed herein will become more apparent from the detailed description set forth below when taken in conjunction with the drawings.

### DETAILED DESCRIPTION

Following below are more detailed descriptions of various concepts related to, and embodiments of, inventive systems, methods and apparatus for protecting a source of visual information and particularly electronic sources of visual information. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

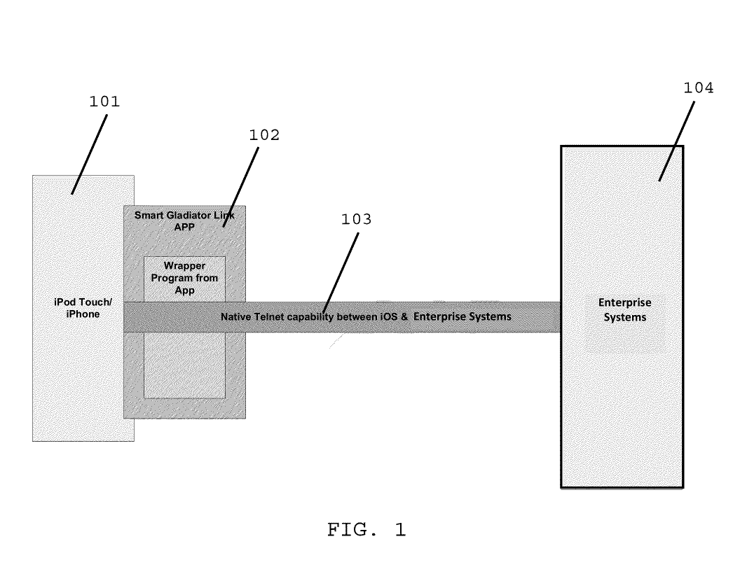

FIG. 1 is a diagram illustrating a terminal emulation system in accordance with exemplary inventive embodiments. A mobile electronic device 101, such as an iPod Touch may be implemented in accordance with exemplary embodiments for hosting a terminal emulator application on device 101. Mobile electronic device 101 may be configured, for example by downloading an application from an online application store, to run an application 102 that provides a user interface on device 101 for establishing, via a wireless communication interface, a telnet or ssh or http or https connection 103 or network protocol with a remote computer or server 104 running a backend system. In various embodiments, mobile electronic device 101 may include a mobile operating system including, but not limited to, Android, iOS, Windows mobile, WebOS, or another mobile operating system.

Depending on the operating system running on mobile electronic device, the terminal emulator application may include, but is not limited to, an iOS application or a Java application. Remote computer 104 may include a mid range computer, such as an IBM AS/400 or other enterprise systems, a mainframe computer, UNIX based server computer, a personal computer, a cloud computing system, a MAC, etc. The telnet or ssh or http or https connection 103 may be implemented via a network such as the internet or a local area network to provide bi-direction interactive text-oriented communication between device 101 and computer 104. The backend system running on remote computer 104 may include enterprise systems including, but not limited to, enterprise resource planning (ERP) systems, inventory control or management systems, transportation management systems, retail point of sale systems, retail inventory merchandising systems, a rental car-check-in/check-out systems, or restaurant order taking systems. While the illustrated embodiments discuss inventory management enterprise system in detail, as demonstrated herein, the scope of exemplary inventive embodiments is not limited thereto.

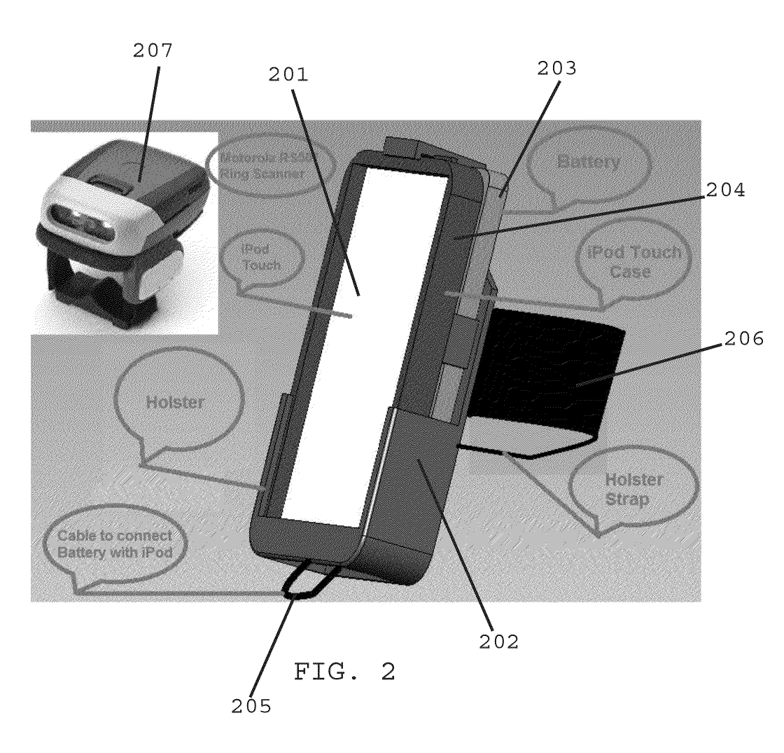

FIG. 2 shows a mobile electronic device for implementing the terminal emulation system of FIG. 1. A mobile electronic device in accordance with inventive embodiments disclosed herein includes a device with a processor, a memory, a tactile user interface, and a weight of less than 1.12 lbs. A mobile electronic device in accordance with various inventive embodiments has a weight of less than 1.1 lbs., a weight of less than 1 lb., a weight of less than 0.9 lbs., a weight of less than 0.8 lbs., a weight of less than 0.7 lbs., a weight of less than 0.6 lbs., a weight of less than 0.5 lbs., a weight of less than 0.4 lbs. or a weight range between any of the aforementioned weights. A mobile electronic device in accordance with various inventive embodiments includes an iPod Touch, an iPhone, a mobile phone with a touch screen or a tactile user interface, an Android watch, an Apple watch.

In FIG. 2, exemplary mobile electronic device 201 is illustrated as an iPod Touch. The mobile device in accordance with various inventive embodiments may include other mobile electronic devices, such as mobile phones, running operating system software such as Android or Windows or other mobile operating systems. As illustrated in FIG. 2, in various embodiments mobile device 201 may be removably coupled to a holster 202, which may include a built in battery 203 which may be connected to device 201 by input device such as cable 205. Holster 202 may be configured to hold device 201 when device 201 is disposed in a protective case 204. Holster 202 may include one or more straps 206, which may be adjustable, elastic, or in other suitable forms for removably coupling the device to a user. In some embodiments, device 201 may be positioned in a hand held holster. Device 201 may be communicatively coupled, for example wirelessly coupled, to a scanner or detection device, such as ring scanner 207. In various embodiments, device 201 may be coupled to a bar code scanner, an imager for scanning 2D and 3D barcodes, near field communication detection device, an RFID scanner, or other detection device. In various embodiments, the scanner or detection device may be integral with the mobile electronic device. In various embodiments, an image or video capture device of the mobile electronic device may be implemented for object detection, scanning etc.

FIG. 3 illustrates another mobile electronic device embodiment for implementing the terminal emulation system of FIG. 1. As depicted in FIG. 3, mobile electronic device 301 may be coupled to harness 302 configured for attachment to the arm of a user 303, by one or more straps 304 and wireless coupled to scanner 305 configured for scanning data from product 306 and transmitting information to device 301 based on the scanning for processing through the terminal emulation portal hosted on device 301 to communicate with, for example, an inventory control system, warehouse management systems, or ERP systems. Scanner 305 may include a Barcode ring scanner like Honeywell 8650 scanner with battery

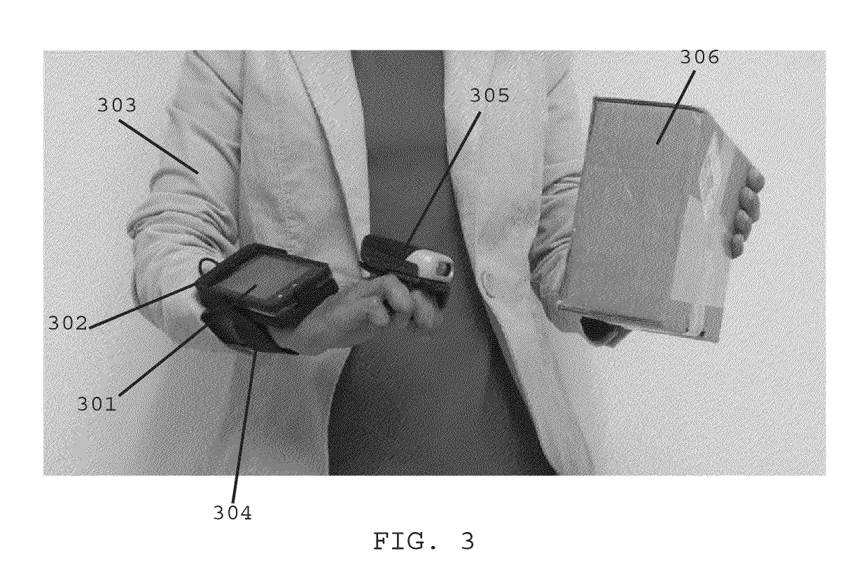

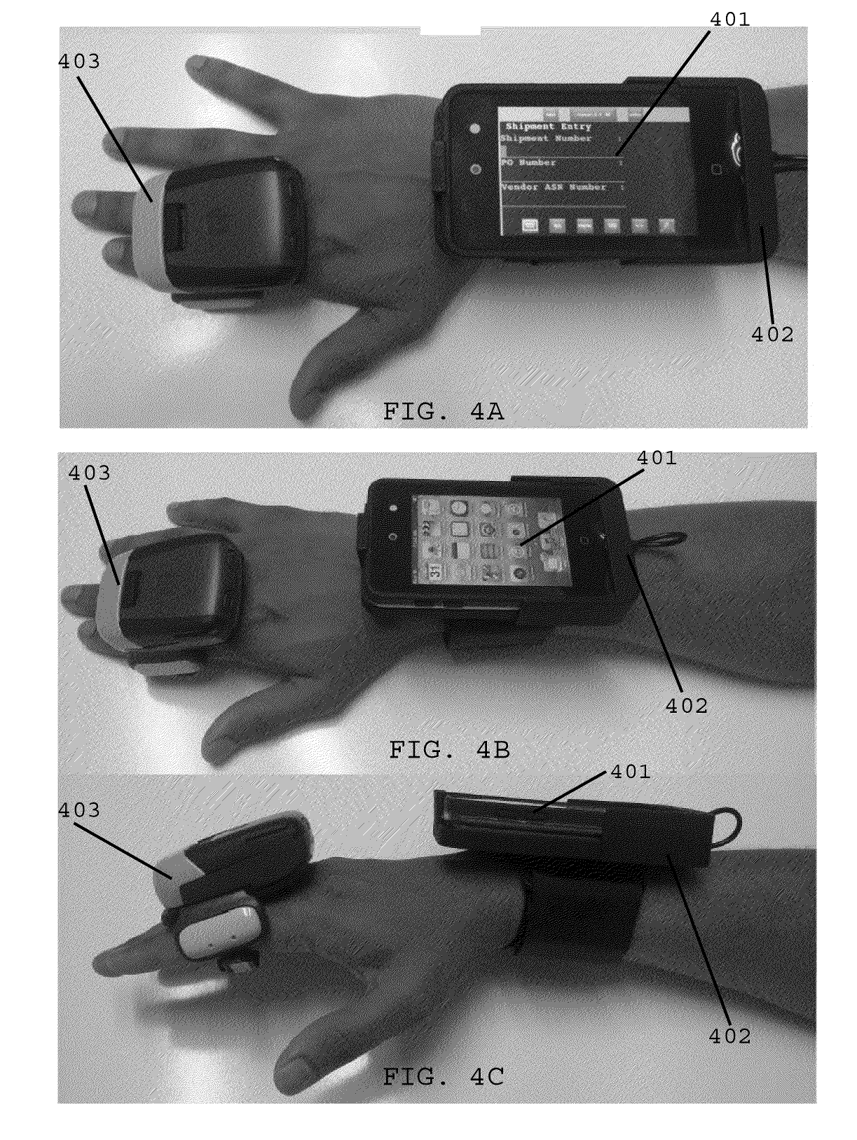

FIG. 4 illustrates a wearable sleeve for holding a mobile electronic device implemented for terminal emulation on an operators arm in accordance with exemplary inventive embodiments. As demonstrated in the illustrated embodiment, sleeve or harness 402 may be configured for removably coupling with mobile electronic device, iPod touch 401. Device 401 may be wired or wireless connected to scanner 403, which may include, but is not limited to a blue-tooth scanner, for scanning the barcodes in the products, cases, locations as part of their operations for faster inputs.

FIG. 5 shows a case for increasing impact resistance and durability of a mobile electronic device implemented for terminal emulation in accordance with exemplary inventive embodiments. Case 501 may include an integral battery compactly configured to connect directly to a mobile device via connection 502.

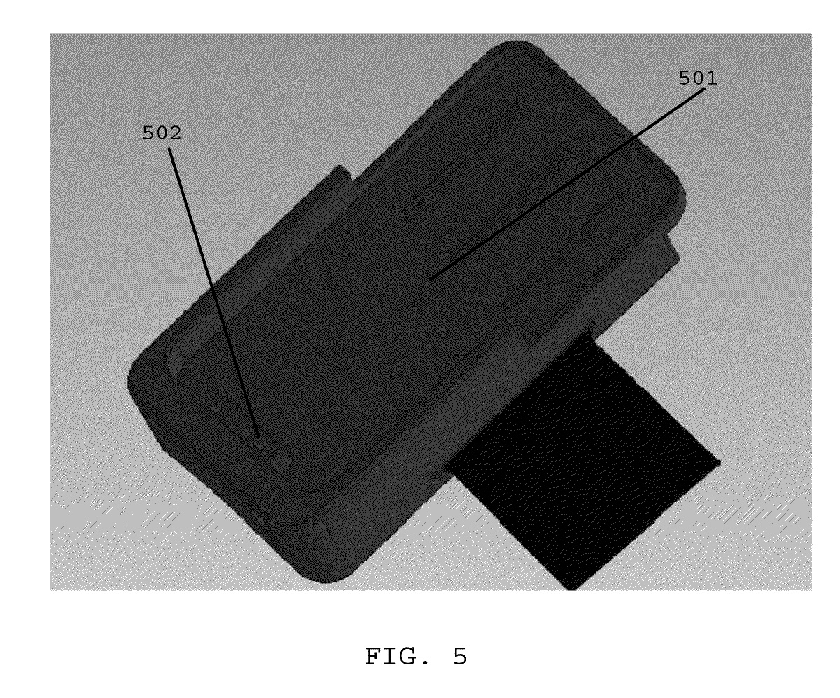

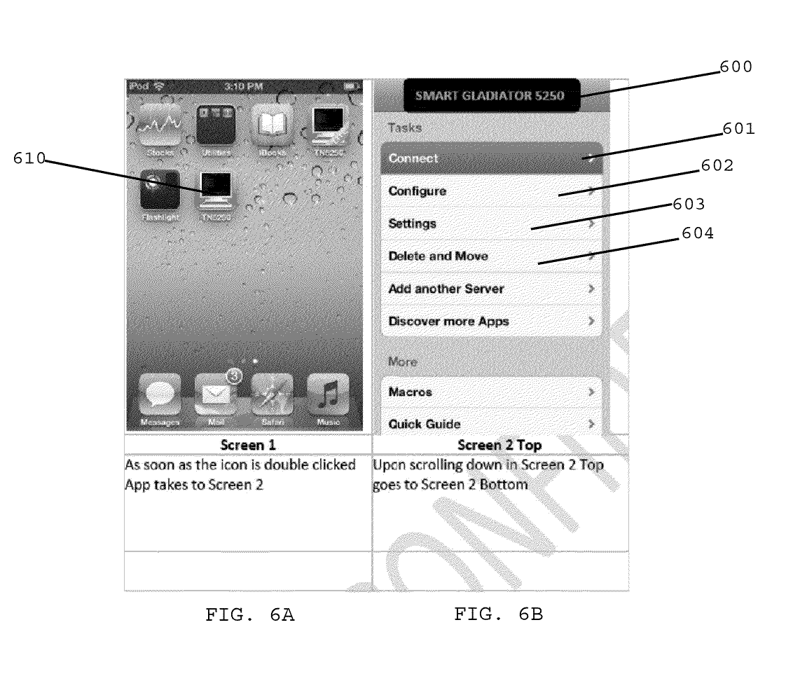

FIG. 6A illustrates a display of a device, such as an iPod touch, having a terminal emulation application, icon 610, in accordance with exemplary inventive embodiments disclosed herein installed therein. Selecting application 610 via the touch screen display initiates the application as further demonstrated in FIG. 6B.

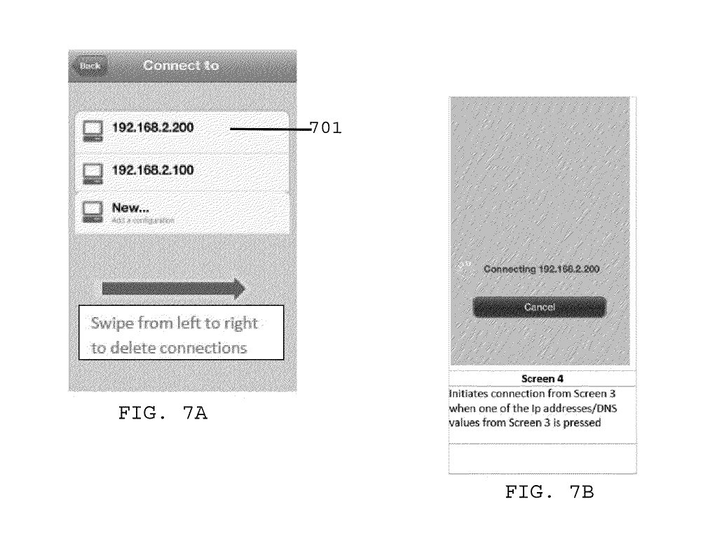

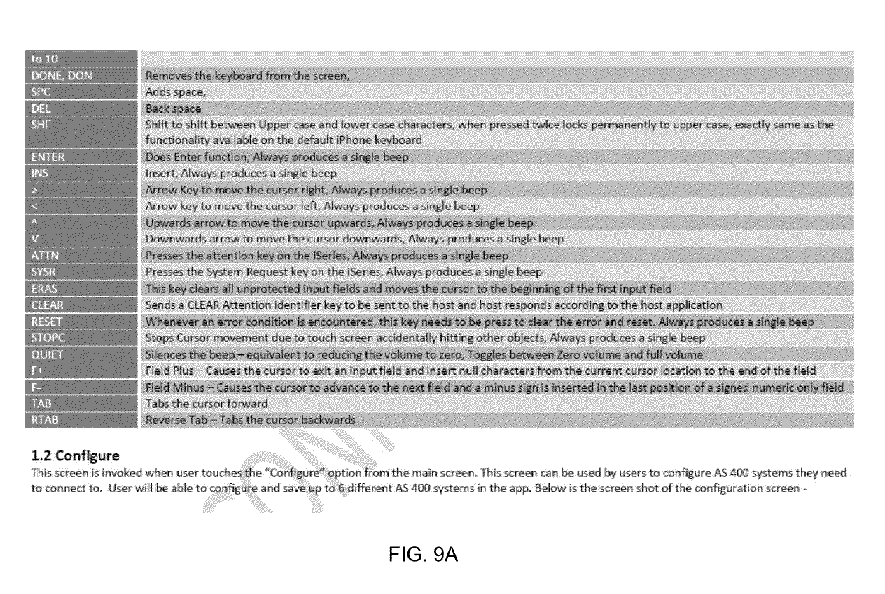

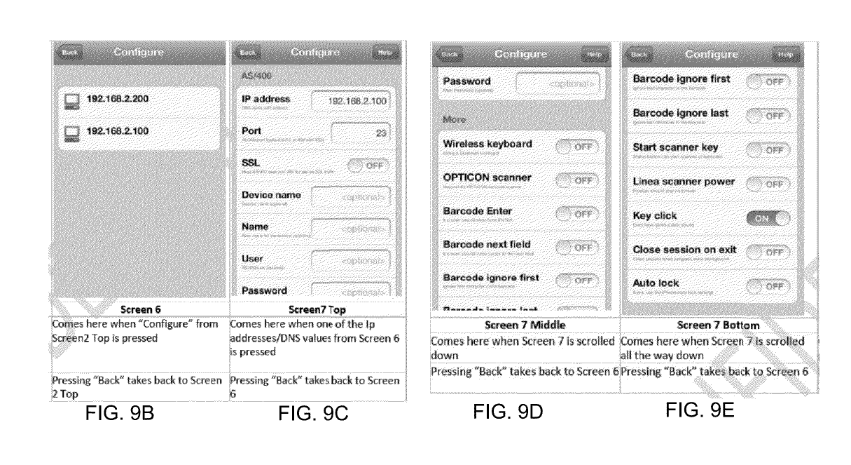

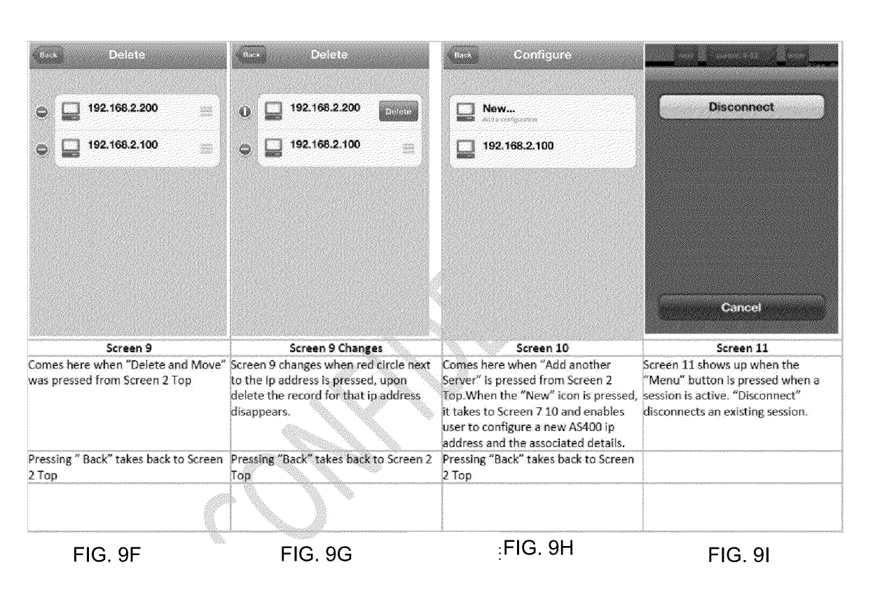

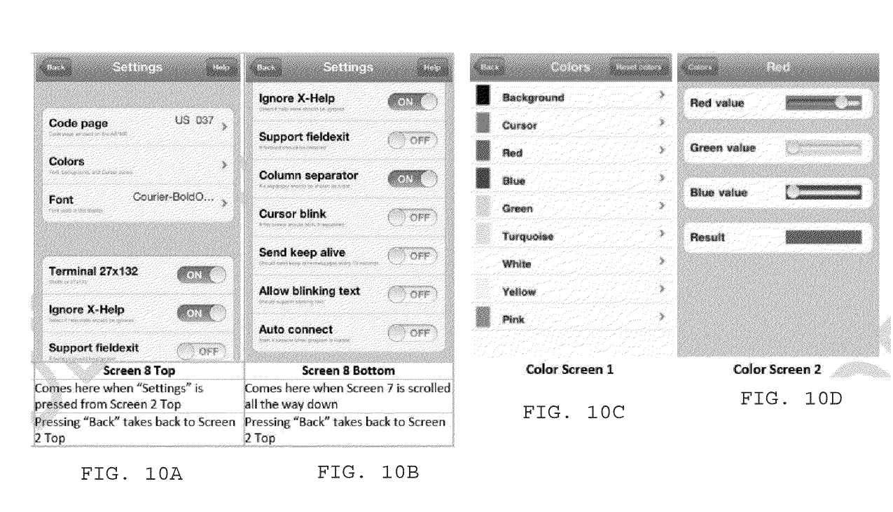

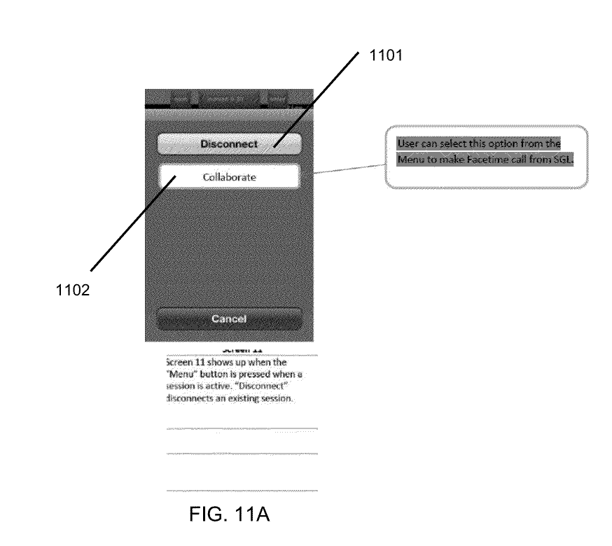

FIG. 6B provides a screen shot of an initiation screen displayed on a mobile device at the start of a terminal emulation session in accordance with exemplary inventive embodiments. Screen 600 may be displayed on a mobile electronic device such as iPod touch device 101 when the terminal emulation application is initiated on the device. As demonstrated in FIG. 6B, initiation of the application may enable a variety of functions such as connection function 601, configure function 602, settings function, 603, delete function 604 or other functions implemented in accordance with various embodiments. Connect function 601 enables device 101 to connect with a remote computer device, such as device 104, thereby creating a new session. Touching the connection function 601 on the screen will bring up additional options and facilitate initiation of additional processes discussed in greater detail in connection with FIGS. 7A and 7B. Configure function 602 causes device 101 (for example via a processor running the terminal emulation application) to display a screen that allows a user to configure the connection information related to remote computer device 104 to which the device connects, as will be discussed in greater detail in connection with FIGS. 9A-9E. Settings function 603 causes device 101 to display a screen that allows a user to configure settings, which may be unrelated to connectivity such as font, code page, screen size, etc., as will be discussed in greater detail in connection with FIGS. 10A-10D. Delete and move function 604 causes device 101 to display a screen that permits the user to delete a configured remote computer. In particular embodiments, screen 600 may include a collaborate tab in the task menu. The collaborate option opens an interface with a communication interface such as Facetime and permits a user to configure their contact in that interface.

FIGS. 7A and 7B show screen shots of the connection screens displayed on a mobile device at the start of a terminal emulation session in accordance with exemplary inventive embodiments. Once a user initiates a connection procedure via connection function 601, the terminal emulation application may cause device 101 to display a list 701 of remote computer devices (which may be identified by their IP address or other naming convention), such as device 104, that the system running on device 101 has been configured to connect to. A user can select a computer from list 101. A user also has the option to select option 702 “New” to add new server to the list. When a user selects option 702 “New” the application takes the user to the “Configure” screen described in FIGS. 9A-9I. In particular embodiments, a user has the option 703 that permits the user to perform a swipe and delete function of the configured connections. A user may perform the action of swiping across the screen from left to right to perform the delete function. This action will take the user to screen 9 shown in FIGS. 9F-9I.

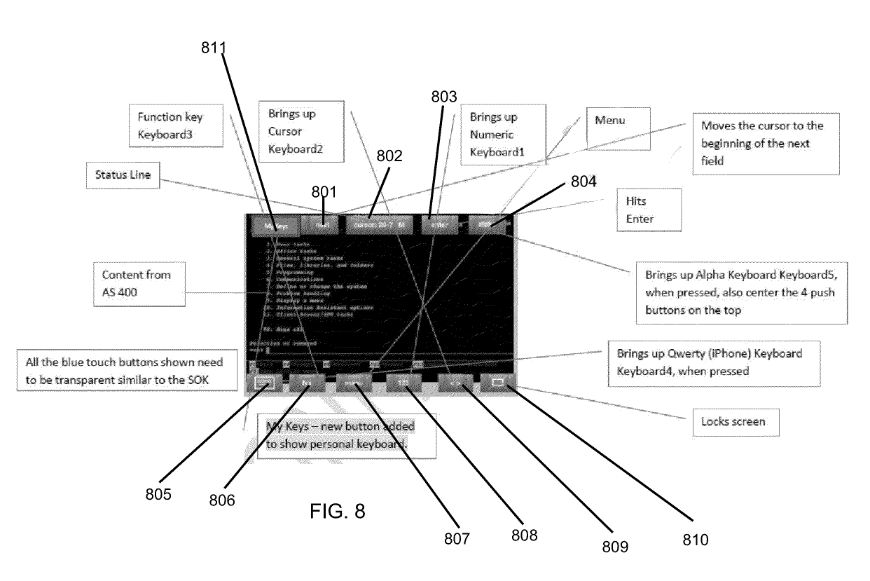

In response to a user selecting a computer from list 101, the application causes device 101 to attempt to wirelessly establish a telnet or ssh or http or https connection with the selected computer, which connection activity may be indicated by the display screen illustrated in FIG. 7B. If the application is unable to connect device 101 with the selected computer, an error message may be displayed on device 101. If the application, establishes a connection with the selected remote computer, the terminal emulation such as depicted and discussed in connection with FIG. 8 may be displayed. When the connection with the selected computer is established and the screen of remote computer 104 is displayed, pressing the home bottom device 101, such as the iPod touch home button to go to iPod home screen, should persist the session if a “Close Session on Exit” configuration setting is in OFF mode. A user may touch the application 610 icon to get back and continue in the remote computer session from where he left off. If the “Close Session on Exit,” shown in FIG. 9E, configuration setting is in ON mode, the application 102 disconnects the remote computer session and exits. Accordingly, when the user re-enters the application 102, after exiting, the user is taken to the session initiation screen.

In various embodiments, establishing a telnet or ssh (secure shell) or http (hypertext transfer protocol) or https (hypertext transfer protocol secure) connection may cause the display screen of device 101 to transition from portrait to landscape. The screen orientation may be locked and may stay in landscape mode during the connection in accordance with various embodiments. The screen orientation may return to portrait mode once the connection with the selected remote computer is terminated or disconnected in accordance with various embodiments.

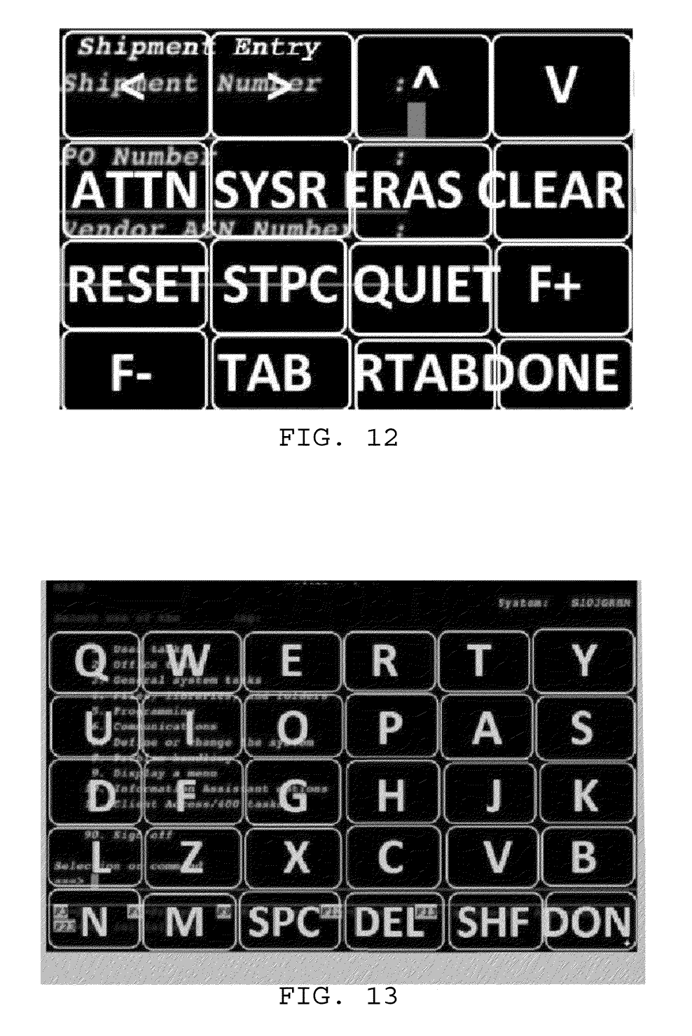

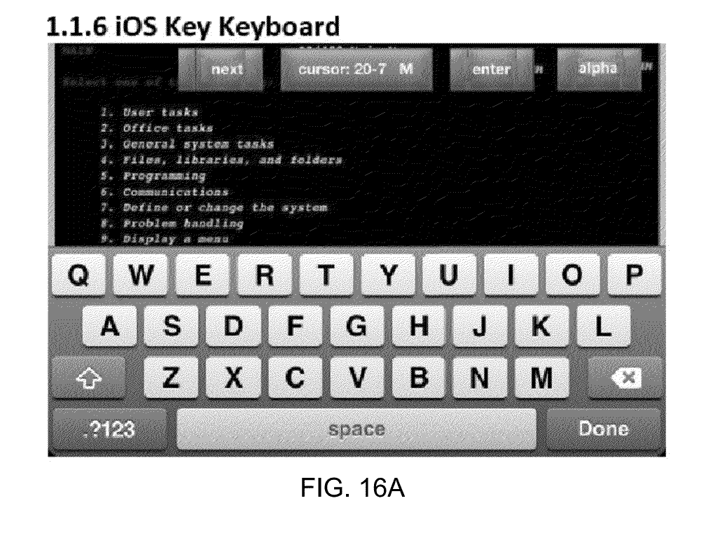

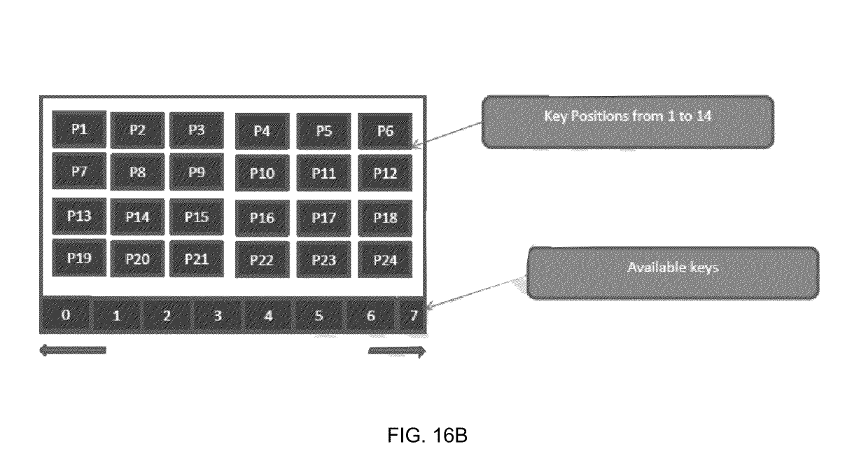

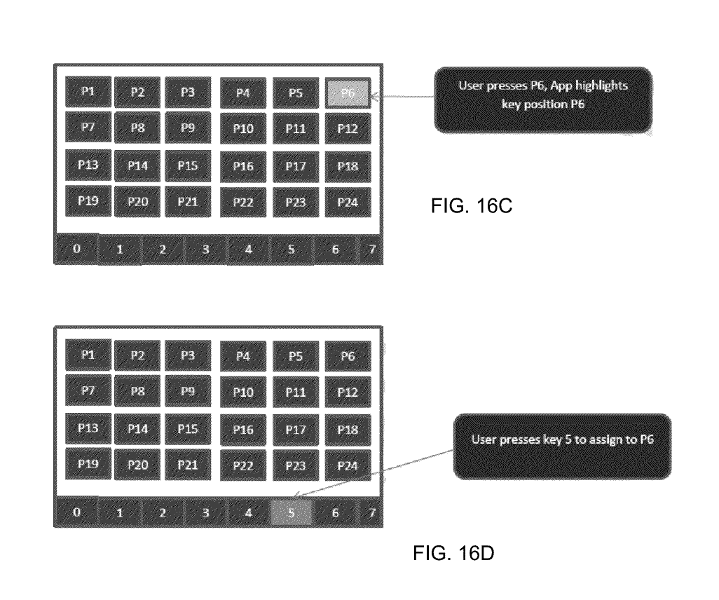

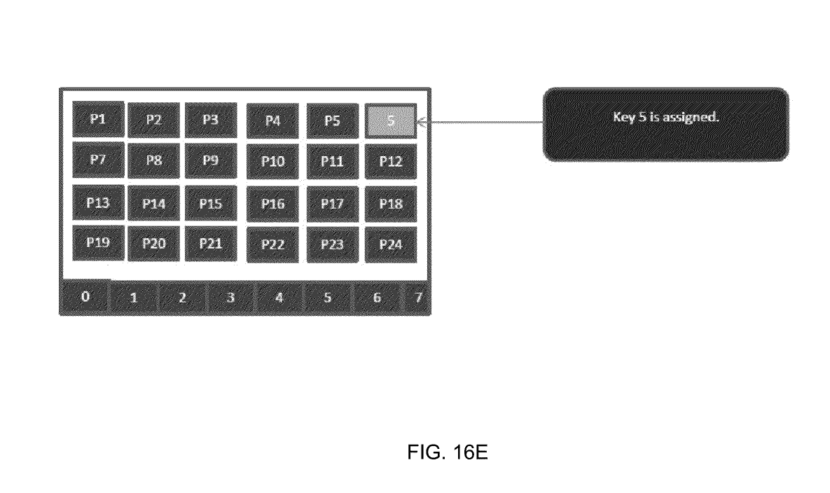

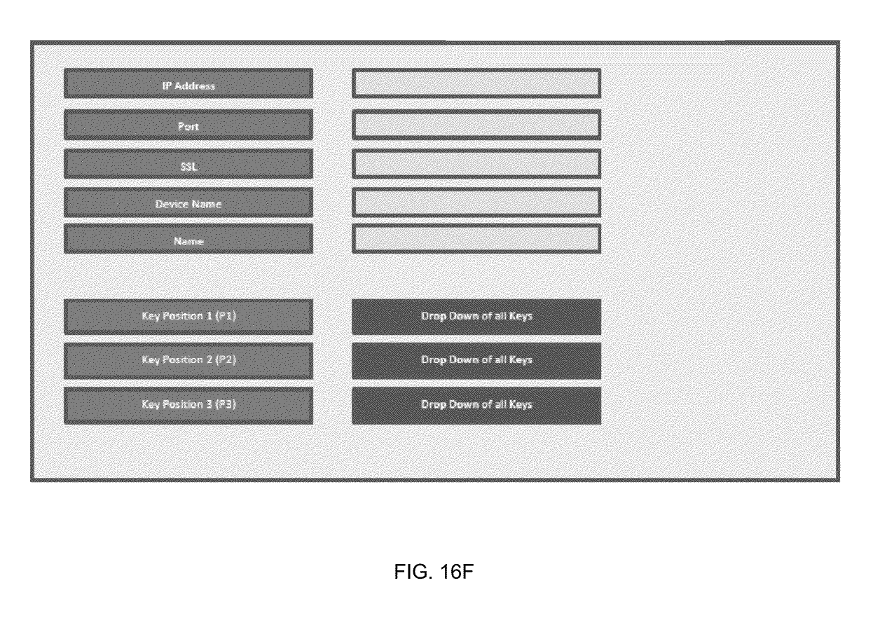

FIG. 8 illustrates a screen shot of the emulated terminal as displayed on the mobile device upon connection to a remote computer terminal in accordance with exemplary inventive embodiments. As shown in FIG. 8, the content from the remote computer 104 (e.g. AS 400 in the illustrated embodiment) is displayed and in the example embodiment includes 11 soft keys displayed on the screen 801-810 configured to cause specific actions or initiate displays of various soft-overlay keyboards demonstrated and discussed in connection with FIGS. 12-15. Key 801 facilitates moving the cursor displayed on the content display from the remote computer. Key 802 provides a status line that will change based on the status of the terminal and the information being displayed. The status line can indicate a variety of messages including messages that indicate whether a session is active or online, where the cursor is positioned, or whether the remote computer is busy or processing, etc. Key 803 permits the user to enter information or initiate a selection or command. Key 804 causes a soft-overlay alpha keyboard to display on the screen of device 101. Key 805 causes a QWERTY keyboard to be displayed on the display screen of device 101. Key 806 causes a soft-overlay function keyboard to display on the screen of device 101. Key 807 brings up a menu. Key 808 causes a soft-overlay numerical keyboard to display on the screen of device 101. Key 809 causes a soft-overlay cursor keyboard to display on the screen of device 101. Key 810 causes the display screen to lock. Key 811 causes display of a personal keyboard described in further detail in connection with FIGS. 16B-16F.

FIGS. 9A-9I illustrate screen shots of various configuration parameters selectable via a mobile electronic device in connection with connecting to a remote computer terminal in accordance with exemplary inventive embodiments. Screens 9A-9F are invoked through a user selecting the configure option 602 on screen 600. In response to such a selection, a user may be presented with the display screen of FIG. 9A, which permits the user to configure the remote computer to which he or she desires to connect. In particular embodiments, a user can configure 6 different remote computers in the application 102. FIGS. 9B-9F provide screen shots of the configuration screens. The configuration screen shown in FIG. 9B provides user with a list of remote computer devices, identified in the illustrated embodiment by their IP address. In response to the user selecting a computer for configuration from the list of FIG. 9B, the user will be permitted to enter or select various options shown in FIGS. 9C-9E regarding configuring the connection to the selected computer. FIG. 9C represents a top screen shot of the selectable configurations.

FIG. 9D represents an intermediate or middle portion of the selectable configurations, which options are viewable in response to a user scrolling down the list. FIG. 9E represents a bottom screen shot of the selectable configurations, which options are viewable in response to a user scrolling to the bottom of the list. For example, the key click selection enables the application to cause production of a click sound for every key pressed in all the keyboards. As demonstrated in FIG. 9F-9H, in addition to changing or modifying the connection configuration of listed remote computers, a user may be able to delete or add a new computer or server to the list for configuration and connection thereto. As shown in FIG. 91, once the user has configured the parameters of the electronic device the user can disconnect to exit the session.

FIGS. 10A-10D show screen shots of various settings selectable via a mobile electronic device in connection with connecting to a remote computer terminal in accordance with exemplary inventive embodiments. Screens 10A-10E are invoked when a user selects the configure option 603 on screen 600. FIG. 10A illustrates the top of the setting options and FIG. 10B illustrates the bottom of the settings options. FIGS. 10C and 10D illustrate various layers of the settings they may be entered in response to selecting an option from the menu such as color.

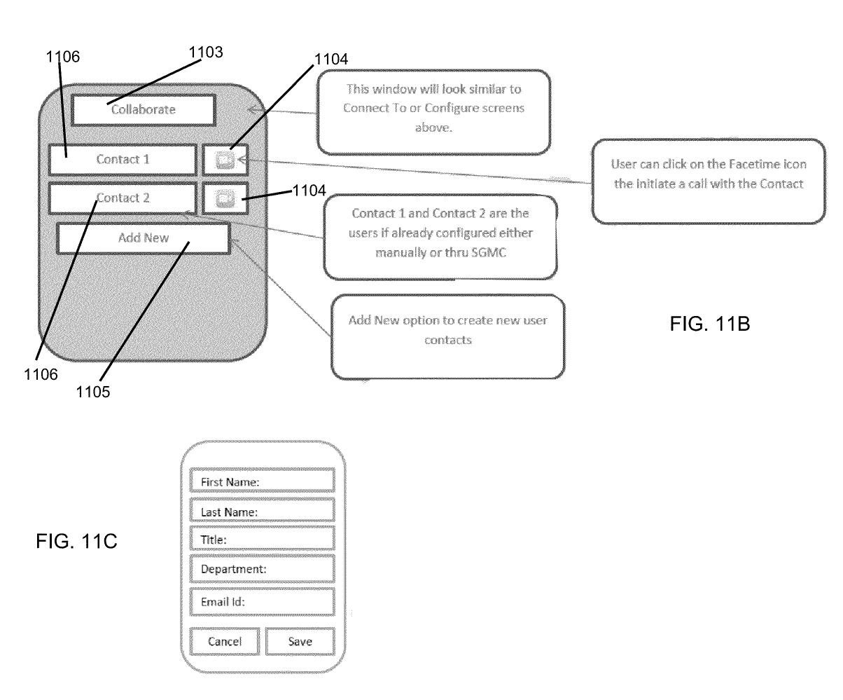

FIG. 11A illustrates a screen shot of a mobile device operable to disconnect from a remote computer terminal, via disconnection option 1101, or collaborate with other users, via collaborate option 1102, in accordance with exemplary inventive embodiments. FIG. 11B illustrates the collaboration screen displayed in response to selection the collaboration option 1102. As shown in FIG. 11B, the collaboration option 1102 allows a user to be able to manually add the contacts that the device can initiate calls, such as Facetime calls, when the user touches the collaborate option 1103. The collaboration screen shown in FIG. 11B also list the contacts 1106 already configured in the application 102 and includes a button to add new contacts to the application 102, in accordance with particular embodiments. The contacts 1106 already configured in the application 102 will be displayed in a list. In response to selection of a user from the list, the application causes the following information, shown in FIG. 11C, to be displayed: First Name Last Name, Title, in accordance with particular embodiments. For example, if Joe Smith is a user already configured in the system and his title is configured as Shipping Supervisor, the list will display Joe Smith, Shipping Supervisor

Contacts in the application may be deleted by swiping the screen sideways, similar to delete action on the connection screen, in accordance with example embodiments. When users do the swipe action, a delete icon may appear next to all the users in the list. A user selects the delete icon to delete the contact from the application. A user can initiate a collaborative call, such as Facetime call, with one of the contacts 1106 in the list by selecting the call icon 1104, such as a Facetime icon, on the right side of the contact. When a user presses call icon 1104, the application 102 initiates a Facetime call directly, in accordance with particular embodiments. The application 102 may be edited by selecting the contact from the collaborate screen. When a user selects a contact, the screen that is displayed may be the same as the Add New Contacts screen with the distinction being that the fields are already populated with the existing values. A user clicks on “Add New” option 1105 at the bottom to create new contacts in the application 102. When the Add New option 1105 is selected, the display shown in FIG. 11C is displayed.

A terminal emulation and connection application, in accordance with inventive embodiments disclosed herein running on a mobile device such as the iPod Touch enables a user to interact the mobile device with enterprise systems running on a remote computer such as the IBM Series I/AS 400 computer using the touch screen interface of the mobile electronic device. Inventive embodiments disclosed herein provide a soft-overlay keyboard superimposed on the terminal emulation display displayed via the touch screen display of the mobile device. The soft-overlay keyboard provides a virtual keyboard that creates an illusion as if a glass keyboard is placed right above the emulated terminal

The soft-overlay keyboard shown to the user will be bigger and user friendly in comparison to the standard device keyboard, such as the device QWERTY keyboard. The superimposition of the soft-overlay keyboard (SOK) over the content in the screen provides users with bigger keys to interact with while simultaneously continuing to display the information already on the screen. Exemplary embodiments of various SOKs are described below in connection with FIGS. 12-16F.

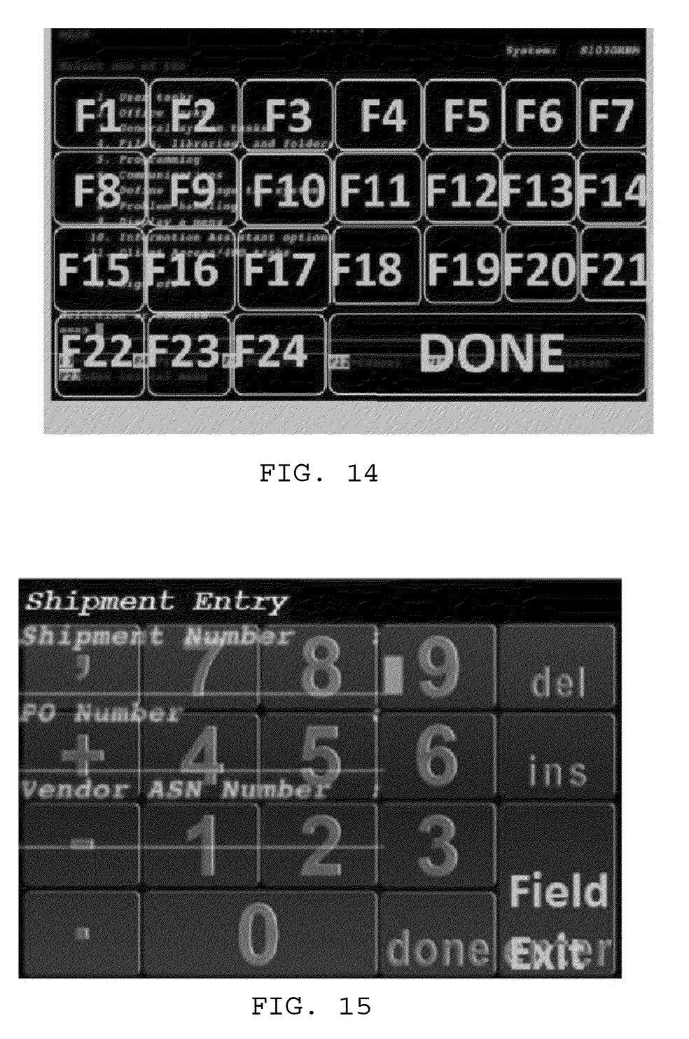

FIG. 12 illustrates a soft-overlay cursor keyboard displayable on a mobile device in connection with connecting the mobile device to a remote computer terminal in accordance with exemplary inventive embodiments. FIG. 13 illustrates a soft-overlay alpha keyboard displayable on a mobile device in connection with connecting the mobile device to a remote computer terminal in accordance with exemplary inventive embodiments. FIG. 14 illustrates a soft-overlay function keyboard displayable on a mobile device in connection with connecting the mobile device to a remote computer terminal in accordance with exemplary inventive embodiments. FIG. 15 illustrates a soft-overlay numeric keyboard displayable on a mobile device in connection with connecting the mobile device to a remote computer terminal in accordance with exemplary inventive embodiments. In accordance with particular embodiments, touching the field exit key sends the field exit code to the remote computer 104 and minimizes the SOK to go back to the content of the computer 104.

FIG. 16A illustrates a QWERTY keyboard of a mobile device being displayed during a terminal emulation session on the mobile device to a remote computer terminal in accordance with exemplary inventive embodiments.

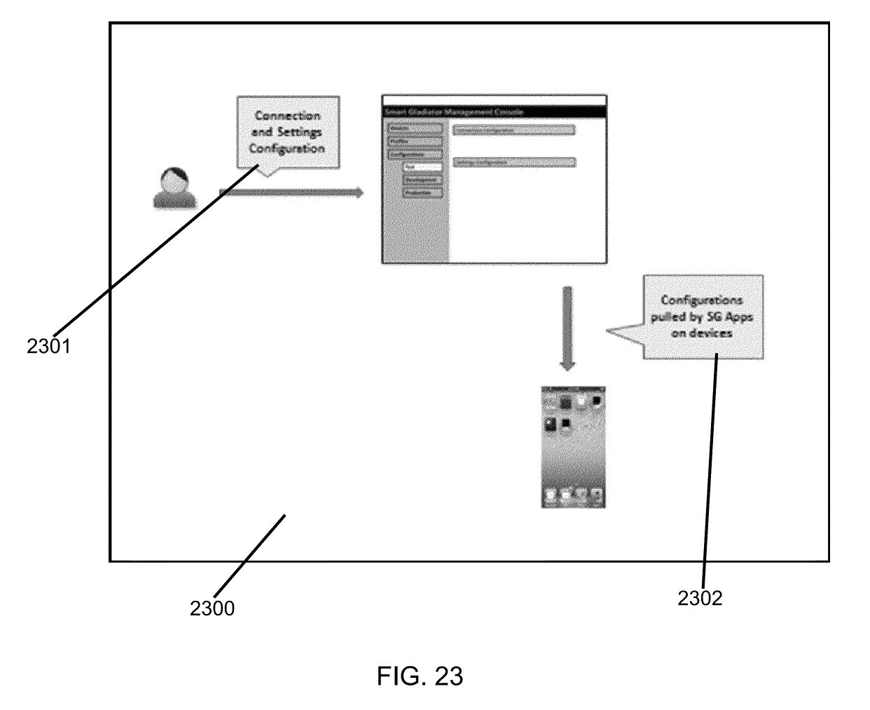

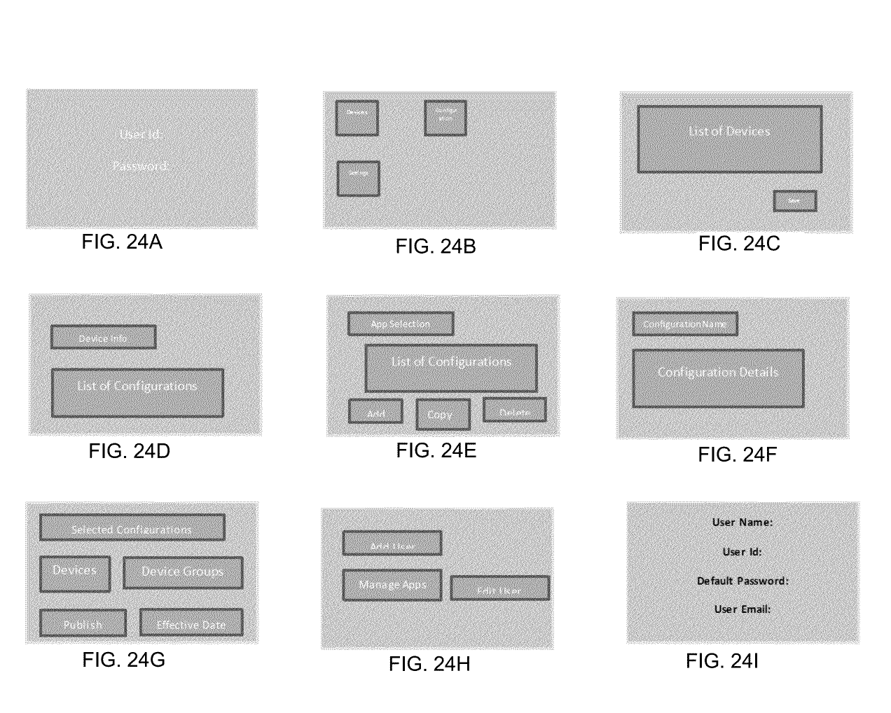

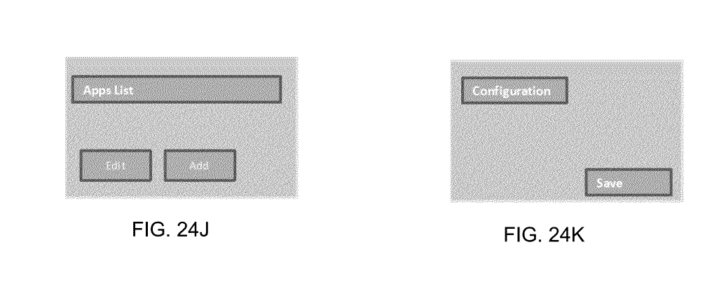

FIG. 16B illustrates a personal keyboard that is displayed when users presses the “My Keys” option 811 from emulated terminal displayed on the mobile device upon connection to a remote computer terminal as shown in FIG. 8. The user has the option of assigning specific keys to key positions on the personal keyboard. The personal keyboard may be of fixed size, with 24 configurable key positions in a 6×4 layout, in accordance with particular embodiments. The user can personalize and assign keys to all 24 key positions or to any of the positions user desires. The personal keyboard can also be configured using a management console, discussed in connection with FIGS. 23-24, and pushed to devices. FIG. 16B shows the display shown to the user when Personal Keyboard option is selected from the emulated terminal. The application 102 may automatically switch to landscape mode when the personal keyboard option is selected and shown. Each key position on the personal keyboard may have a fixed position number assigned to it as shown in FIG. 16B. Key Positions numbers like P1, P2, P3 etc. are also displayed on the screen. These key positions will also be used to assign keys in the management console, discussed in connection with FIGS. 23-24. The bottom row on the screen will display all the available keys that can be assigned to key positions. The bottom row is scrollable from left to right. User can scroll the available keys by making sliding action on the bottom row from left to right and vice versa.

Example available keys that can be assigned to key positions are in table 16.1 below.

TABLE 16.1

| | | |
|---|---|---|
| Numeric Keys | 0, 1, 2, 3, 4, 5, | |
| | 6, 7, 8, 9 | |
| Alpha Keys Upper | A to Z | |
| case | | |
| Alpha Keys Lower | a to z | |
| Case | | |
| Function Keys | F1, F2, F3 | |
| | all the way to F24 | |
| Delete Key | DEL | Performs delete of text and chars |
| Field Exit | FIELD EXIT | Performs Field Exit |
| Space Key | SPC | Adds a blank Space |
| Enter | ENTER | Hits Enter |
| Insert | INS | Inserts a character |
| Alpha | ALPHA | Brings up the alpha keyboard |
| 123 | 123 | Bring up the numeric keyboard |
| . | . | . to indicate decimals can be |
| | | added |
| + | + | Plus sign to make adjustments |
| − | − | Minus sign to make adjustments |
| < | < | Left arrow key to move cursor |
| | | to the left |
| > | > | Right arrow key to move cursor |
| | | to the right |
| \hat{ } | \hat{ } | Up arrow key to make the cursor |
| | | go up (inverted V) |
| V | V | Down arrow key to make the |
| | | cursor go down (V) |
| Page Up | PGU | Page Up |
| Page Down | PGD | Page Down |

As shown in FIG. 16C, to assign a key to a key position, user has to press the key position like, P6, and then press the key to assign, as shown in FIG. 16D. When user presses a key position to assign the key, the application will highlight the key position as shown in FIG. 16E. In accordance with particular embodiments, once a key is assigned to a position, the key position is highlighted in a different color to show user that position is already assigned. To un-assign a key from a key position, user has to double-tap the key. In above example, when user double taps the position with key 5, app will un-assign the key 5 and display P6 on the screen. When user brings up the personal keyboard from the “My Keys” button on the emulated screen, only the key positions with assigned keys will be show to the user.

The management console, discussed in connection with FIGS. 23-24, may be configured to create a personal key board via the user interface shown in FIG. 16F and publish it to devices so that all users of certain type have a standard “personal” keyboard.

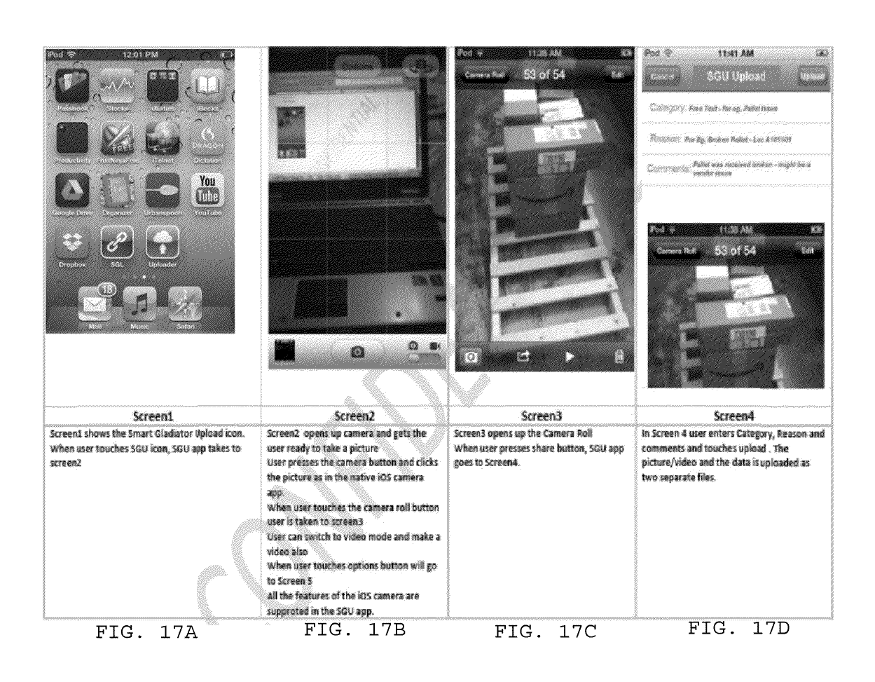

FIGS. 17A-17E depict screen shots of an uploader system transitioning through various processes in accordance with exemplary inventive embodiments. An uploader system is an application in accordance with various inventive embodiments that runs on a mobile device such as an iPod Touch. SGU provides a user interface on the iPod touch device to take pictures and videos and upload them to a portal, such as Google docs or SharePoint, Servers, Computers and other system using variety of protocols like FTP, FTPS, SFTP etc., where users can review them at a later point of time as well as share those pictures with colleagues and business partners. For example, in various embodiments, when a new type, brand, or model of an item is received in a warehouse, the new item may be automatically processed for imaging and the image may be uploaded to an item image database. All the pictures of items stored in the database may be accessible upon request via a mobile electronic device in accordance with exemplary embodiments disclosed herein so that the picture of an item is displayed, for example, during a picking event for verification that the user is picking the correct item. In various embodiments, the uploader system may be running on a mobile electronic device as described herein. In various embodiments the uploader system may be running on a device such as Google glass, wherein the Google glass device is implemented as an input device to obtain images of items of interest, such as inventory items. In various embodiments, the input device may include a mobile electronic device with a user interface configured to receive input via voice commands received from the user.

FIG. 17A is a screen shot showing the uploader icon 1701 for launching the uploader application. FIG. 17B provides a screen shot of the camera application which automatically opens in response to opening the uploader application. From this stage a user can capture an image or video using the native picture and video capture icons of the device. As demonstrated in FIG. 17C, the user may review captured images or videos through device controls such as the camera roll control. Once an image or video is captured the image or video may be selected and uploaded to an FTP site as shown in FIG. 17D. The photo/video is uploaded to the FTP site along with a text file including details such as, the user name of the user creating the image or video, the category of the image, the reason for obtaining the image, additional comments, and a date and time stamp. In various embodiments, the user name may be configured for automatic population upon each use of the device. In various embodiments, the application may be configured to automatically delete the image or video file from the mobile device upon confirmation of successful receipt of the image or video at the FTP site. FIG. 17E provides a screen shot of a settings entry page that may be used to configure the setting of the FTP site.

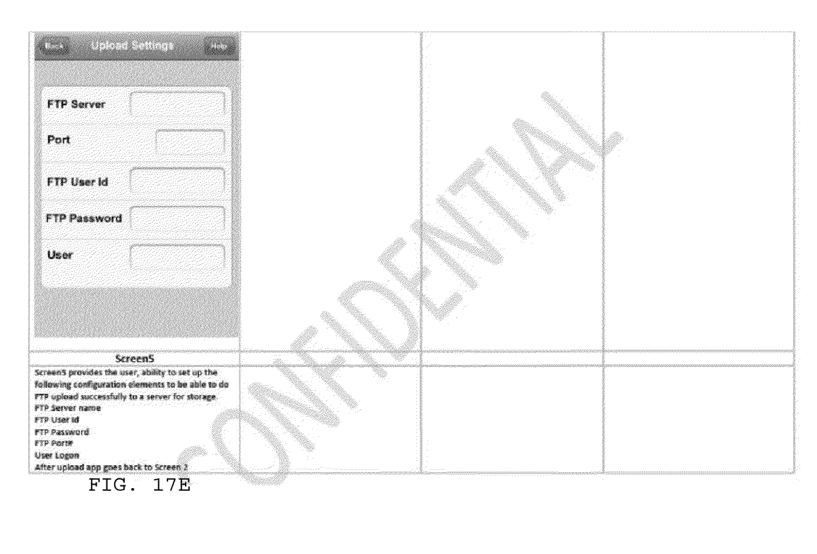

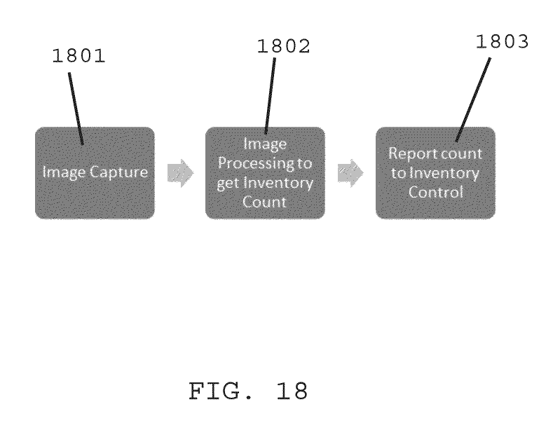

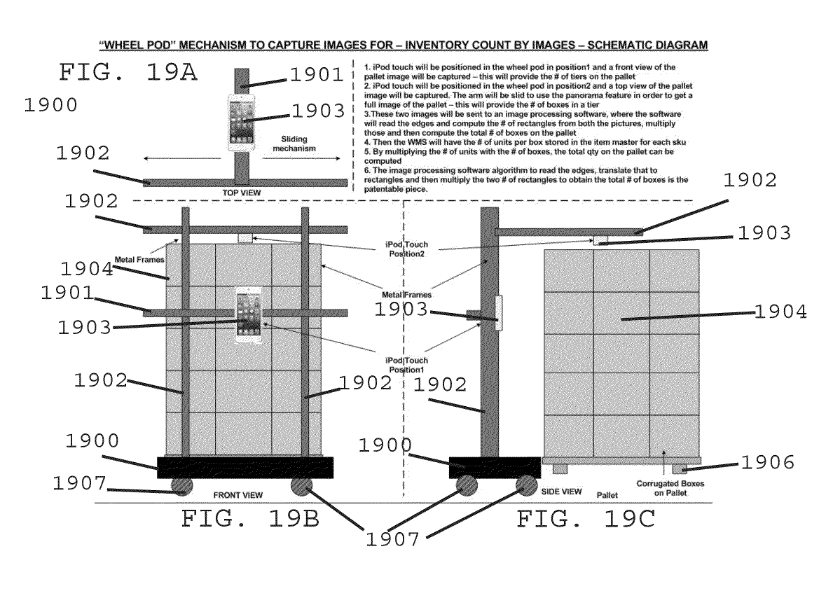

FIG. 18 provides a flow diagram for inventory count by image system in accordance with exemplary inventive embodiments. Inventive embodiments described herein perform inventory count of inventory in a location or a pallet or a truck or any other place that can hold inventory, based on one or more picture of the location with the inventory. The First step is the image capture step 1801. The image of the location or pallet to be counted is captured using device with a camera. Image capture can be performed by an operator with a camera device or automated with a mechanism to capture images of locations, like a camera device that's mounted on a traversing belt or a wheel-pod mechanism as demonstrated in FIGS. 19A-19C. In various embodiments, a panoramic image may be captured as the camera device of a mobile electronic device traverses a side or top of a pallet. The second step 1802 includes processing the image. The image captured is processed using proprietary algorithms to determine the total number of products in the image. The image captured in step 801 is sent to a server/application that has the logic to process the image and get the count. The server application uses heuristic algorithms to determine the inventory count from the picture. Image processing toolkits from programs such as MathWorks may be used to develop heuristics algorithms. The algorithms work by identifying the edges of the boxes and cartons of the inventory, deriving the shapes of the boxes using the edges and then counting the number of shapes in any given image. A standard reference profile of a single unit of inventory may be used to determine the number of units in a given image. Multiple images of the inventory at various views/angles may be required to accurately calculate the count of inventory. This process of inventory count is much faster and accurate than manual counting as user just has to take a picture of a location and the actual counting will happen in the software algorithm. Once the server application has determined the inventory count from the picture, step 803 will be engaged to report the count to the inventory control systems. Some inventory control systems provide APIs or Web Services that can be invoked from the image processing system to send the count information. Count information can also be written in a specific file format for other systems to consume.

FIGS. 19A-19C provides a schematic diagram of an inventory count by image system in accordance with exemplary inventive embodiments. FIG. 19A provides a top view of the inventory count system 1900. As demonstrated in FIG. 19A, the system may be implemented via a movable frame or robotic platform 1901 having a framed structure 1902 configured to position one include one or more image capture devices 1903, such as a mobile electronic device as described herein including, but not limited to, an iPod touch, at various orientations with respect to inventory 1904. Frame 1902 may include movable struts or crossbars 1905 configured to slide from one end the frame to another end of the frame so that one or more images can be obtained of the inventory 1904 contained on the pallet 1906. FIGS. 19B and 19C provide top and side views of inventory count system 1900. System 1900 may include wheels 1907 and may include one or more actuators and robotic control systems to move from one pallet 1906 to another pallet contained in a warehouse.

FIG. 20 provides a screen shot of a Labor Management systems implemented in accordance exemplary inventive embodiments. A labor management system, in accordance with various embodiments, monitors the movement of the users and reports the user location real time to a Warehouse Management System/Labor Management System. This also facilitates further monitoring of users to ensure they stay within their confined working area as well as maintain the amount of distance travelled within the permissible range allowed for a specific role

In the embodiment illustrated in FIG. 20, there are three groups of users 2010, 2010, 2020, and 2030 that are expected to be working confined within their area of work, but one user 2031 of group 2030 seems to be outside his working area, which could raise a flag to the warehouse manager.

The indoor GPS/positioning system enables real time location tracking of operators in the distribution center or warehouse. Various access points in the distribution center are identified and each mobile electronic device may be referenced based on the coordinates from the access points to determine the position of the mobile electronic point from the access points. In the Warehouse management systems/Labor Management systems that are in use today, users report their location by scanning the nearest location to them and often users don't walk to their nearest location but key enter a location from their memory, this creates errors in the labor movement data that is captured, whereas with the present device, users location can be fed to Labor Management systems real time.

The indoor GPS/positioning system enables warehouse managers to monitor operators within their confined working area using a graphical user interface. For example a Consumer goods DC might have three major zones, Kitchen, Office and Home goods zones. Operators are assigned work to keep themselves within a specific zone, so that their movement as minimal and time is spent on executing tasks instead of travelling from point A to point B. With a graphical dashboard like the one shown above leveraging the real time location capabilities with the present device, Warehouse managers are able to monitor operators real time for staying within their zones and hence efficient utilization of labor

The indoor GPS/positioning system enables warehouse managers to monitor the amount of distance travelled by operators. The distance travelled by operators is measured on a daily basis based on their role. For example a picker's daily travelled distance could be in the range of 10,000 feet to 12,000 feet, similarly a replenishment user's daily travelled distance could be in the range of 8,000 feet to 10,000 feet. Any other operator performing a similar role with distance travelled outside this range is a flag to analyze the nature of the job he is doing, as this could be an opportunity for improvement as he may be doing something wrong.

FIG. 21 provides a screen shot of an uploader application that permits viewing and uploading of pictures, videos and documents of entities or texts, which may be accessed once an image or video is captured as shown in FIG. 17C and selected as shown in FIG. 17D for uploading to an FTP site. The entities may include, but are not limited to, the starting item number of a product, a case number, a shipment number, a purchase order number, and a load number. The application may be used to view a picture or video or PDF document of the entity that is stored in the FTP server as well as to take a picture or video and upload it for an entity in FTP server. Once an item is selected, for example by text selection, the user is shown four options, in accordance with particular embodiments. The four options include the option to view a picture, vie a video, view a document, or upload. As demonstrated in FIG. 21, the view options may be selected via view option 2101 and the upload option may be selected via upload option 2102. In response to selecting view picture mode, the lookup application obtains the files from local cache, if the caching is enabled and the file exists in local cache, or the lookup application connects to the FTP server configured for View mode and looks for the files. In particular embodiments, the lookup application looks for the files in the following order:

1. PNG file with exact name as the text selected.
2. JPEG file with exact name as the text selected.
3. GIF file with exact name as the text selected.
4. PNG file with name that contains the text selected.
5. JPEG file with name that contains the text selected.
6. GIF file name that contains the text selected.
If there are multiple files matching any one criterion, then the latest file may be selected. After the picture file is selected, the lookup application downloads the image and displays it to the user in a separate window. The downloaded file may also be saved in local cache if the caching is enabled and space is available in local cache. The user may have the option to close the window and come back to the lookup application session to continue a transaction. In response to selecting view video mode, the lookup application obtains the files from local cache, if the caching is enabled and file exists in local cache, or the lookup application connects to the FTP server configured for View mode and look for the files. In particular embodiments, the lookup application looks for the files in the following order:
1. MP4 file with exact name as the text selected.
2. MP4 file name that contains the text selected.
If there are multiple files matching any one criterion, then the latest file may be selected. After the video file is selected, the lookup application downloads the video and displays it to the user in a separate window. The downloaded file may also be saved in local cache if the caching is enabled and space is available in local cache. The user may have the option to close the window and come back to the lookup application session to continue a transaction. In response to selecting view document mode, the lookup application obtains the files from local cache, if the caching is enabled and the file exists in local cache, or the lookup application connects to the FTP server configured for View mode and looks for the files. In particular embodiments, the lookup application looks for the files in the following order:

1. PDF file with exact name as the text selected.

2. PDF file name that contains the text selected.

If there are multiple files matching any one criterion, then the latest file may be selected. After the document file is selected, the lookup application downloads the document and displays it to the user in a separate window. The downloaded file may also be saved in local cache if the caching is enabled and space is available in local cache. The user may have the option to close the window and come back to the lookup application session to continue a transaction.

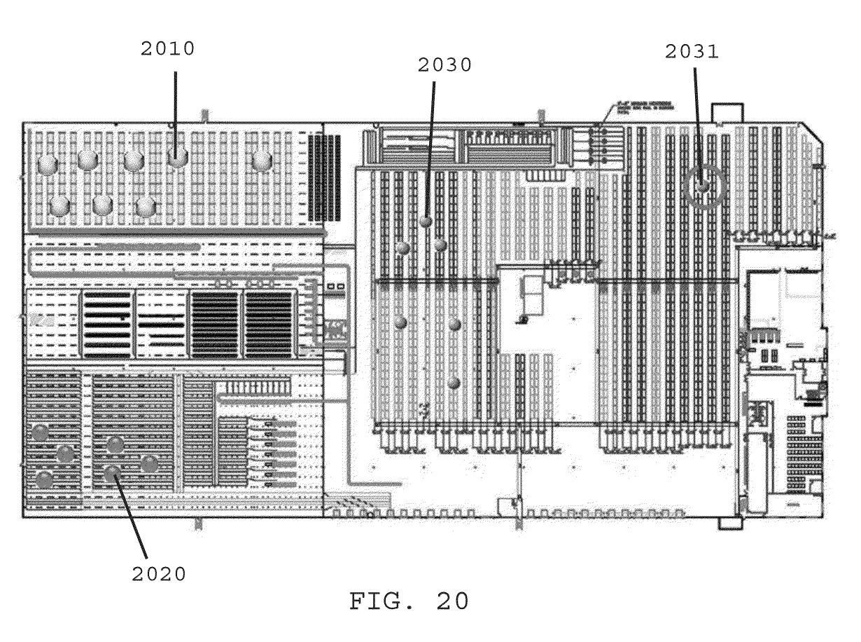

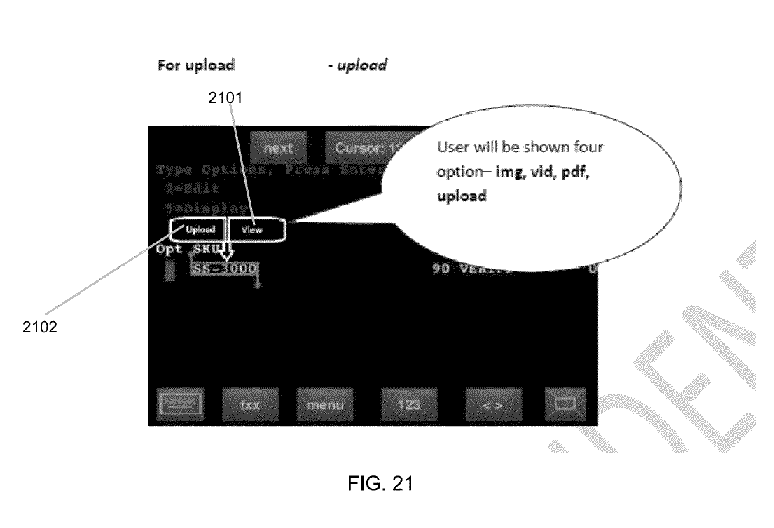

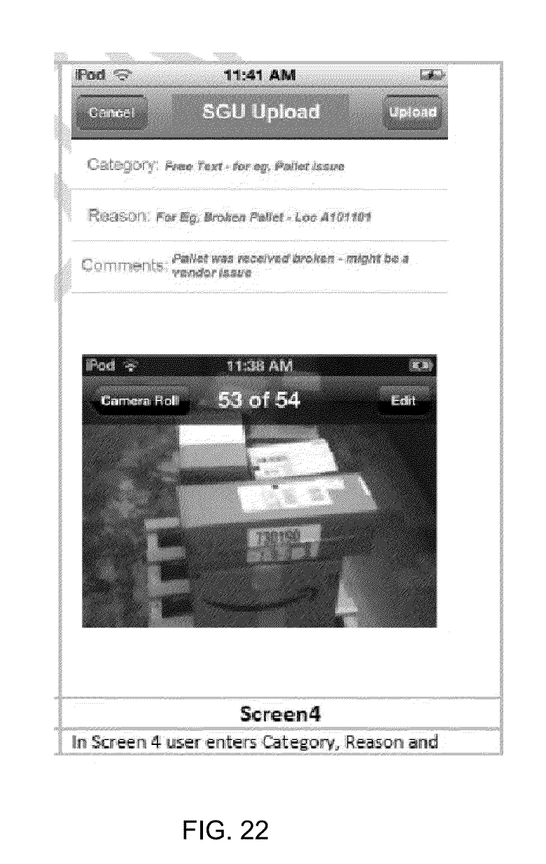

In response to selecting upload option 2102, the lookup application causes a display of the uploader interface illustrated in FIG. 22. The user will be able to capture photo or video using the camera of the device, such as the iPod Touch camera, and upload it to the FTP server configured for Upload. A picture or video and the associated data may be uploaded to the FTP server as two separate files.

FIG. 23 illustrates the management console application that may be used to configure the other application disclosed herein in accordance with particular embodiments. The management console application may be used system administrators responsible for monitoring the devices disclosed herein and the applications running thereon. The management console application may be deployed on a customer's network or it may be implemented by a cloud-based deployment. Using the management console application, a central user can manage and push configuration changes for to all devices managed by the management console application. Using the management console application, a central user can view and configure the devices that are registered with the management console application and view the configurations in the devices for every application managed by management console application. Once the configurations are created, the user of the management console application can publish a specific configuration or a group of configurations across multiple applications to one or multiple devices. The management console application 2300 includes two main components. The first component includes web-based tool 2301 used to create the configuration changes. The second component includes application changer 2302 that pushes the created configuration to the device to cause the application running on the connected devices to accept the configuration changes.

FIG. 24A shows the access screen for the management console application. The access screen provides a user interface for a user to enter a user I.D. and password.

FIG. 24B shows the main screen for the management console application that allows the user of the management console application to select devices, adjust configurations, and modify settings.

FIG. 24C demonstrates the user interface displayed in response to a user selecting devices on the main screen for the management console application. The user interface may list all of the configured devices and related information including, but not limited to, the device group, the device name, a device serial number, a device description, a device type, a device status, and a device update date. In particular embodiments, a user can click on the device name to view the aforementioned device details, as shown in FIG. 24D

FIG. 24E demonstrates the configuration interface displayed in response to a user selecting the configuration option on the main screen for the management console application. In particular embodiments, when a user selects an application or set of applications from the application option, the management console application pulls all configurations tied with the selected applications and display the information.

FIG. 24F shows the user interface displayed when a specific configuration is selected from the interface of FIG. 24E. The user may be permitted to edit the configuration, copy the detail, publish the configuration details, and unpublish the configuration details.

FIG. 24G shows the user interface displayed in response a publication request. The user interface of FIG. 24G permits the user to select the device or device group for receipt of the configuration. The user interface of FIG. 24G permits the user to select a date and time for publication and will proceed with the publication once the publish options is selected.

FIG. 24H is the user interface displayed in response the user selecting the settings options on the main screen shown in FIG. 24B. The settings user interface permits the management console user to perform maintenance on the console, to edit information, to add users, and to add new applications for management.

FIG. 24I shows the user interface displayed when a new user is added via the settings options produced via the display for FIG. 24H.

FIG. 24J shows the display screen where user will be able to view all the apps managed by management console application and FIG. 24K shows the display screen that permits a user to add new applications or edit application to be managed using the management console application.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A mobile electronic device for terminal emulation comprising:
a touch screen display,
a transmitter configured for bi-directional wireless communication, and
a processor configured to provide a user interface to the mobile electronic device, wherein the mobile electronic device connects, via the transmitter, to at least one computer system remote from the mobile electronic device, the processor further configured to cause display of a soft-overlay keyboard on the touch screen display, wherein the soft-overlay keyboard is superimposed on content displayed on the touch screen display; and
a harness removably coupled to the mobile electronic device.

2. The mobile electronic device of claim 1, wherein the user interface is at least one of a telnet, a ssh, a http and a https user interface.

3. The mobile electronic device of claim 1, further comprising an imager coupled to the mobile electronic device.

4. The mobile electronic device of claim 1, further comprising a scanner coupled to the mobile electronic device.

5. The mobile electronic device of claim 4, wherein the scanner is a bar code scanner.

6. The mobile electronic device of claim 4, wherein the scanner is a ring scanner.

7. The mobile electronic device of claim 1, wherein the at least one computer system includes an inventory management system.

8. The mobile electronic device of claim 1, wherein the mobile electronic device includes an image capture device.

9. The mobile electronic device of claim 1, wherein the mobile electronic device includes a video capture device.

10. The mobile electronic device of claim 8, wherein the processor is further configured to upload at least one of an image obtained by the image capture device to a transfer protocol server.

11. The mobile electronic device of claim 1, wherein the soft-overlay keyboard includes at least one of an alpha, numeric, function and cursor key keyboard.

12. The mobile electronic device of claim 1, wherein the keys of soft-overlay keyboard are configured in response to a selected function.

13. The mobile electronic device of claim 1, wherein the mobile electronic device includes an RFID reader.

14. A system for emulating a terminal on a mobile electronic device, the system comprising:
a user interface engine configured to wirelessly connect the mobile electronic device to at least one computer system;
a soft-overlay keyboard generator configured to cause on a touch screen display of the mobile electronic device, via at least one processor of the mobile electronic device, a display of a soft-overlay keyboard on the touch screen display, wherein the soft-overlay keyboard is superimposed on content displayed on the touch screen display.

15. The system of claim 14, wherein the user interface engine is configured to wirelessly connect the mobile electronic device to at least one computer system via at least one of a telnet, a ssh, a http, and a https.

16. The system of claim 14, further comprising an RFID reader, the RFID reader configured to transmit a message to the at least one computer system in response to receipt of a detected RFID signal.

17. The system of claim 14, further comprising a monitoring module, the monitoring module configured to store device handling information.

18. The system of claim 17 wherein the monitoring module stores the location of the device based on GPS data.

19. The system of claim 17 wherein the monitoring module stores information in response to activation of the telnet user interface.

20. A system for configuring a mobile device for enterprise use, the system comprising:
an application disabling engine, the application disabling engine configured to disable one or more applications running on the device, the one or more application selected from the group consisting of an internet browser, a gaming application and a music player
an installer configured to download an enterprise application on the mobile device, the enterprise application including:
a user interface engine configured to wirelessly connect the mobile electronic device to at least one computer system, and
a soft-overlay keyboard generator configured to cause on a touch screen display of the mobile electronic device, via at least one processor of the mobile electronic device, a display of a soft-overlay keyboard on the touch screen display, wherein the soft-overlay keyboard is superimposed on content displayed on the touch screen display;
an identification requester configured to obtain a user identification and a user password;
an application restrictor, the application restrictor configured to restrict at least one communication application installed on the device to operation with at least one user from a pre-defined user group.

21. The system of claim 20 wherein the user interface engine is configured to wirelessly connect the mobile electronic device to at least one computer system via at least one of a telnet, a ssh, a http, and a https.

22. An inventory management system, the system comprising:
a user interface engine configured to wirelessly connect a mobile electronic device to at least one computer system;
a soft-overlay keyboard generator configured to cause on a touch screen display of the mobile electronic device, via at least one processor of the mobile electronic device, a display of a soft-overlay keyboard on the touch screen display, wherein the soft-overlay keyboard is superimposed on content displayed on the touch screen display; and
an image retriever, configured to facilitate selection of an inventory item from an inventory image database and cause display of an image of a selected inventory item on the touch screen display.

23. The inventory management system of claim 22 wherein the user interface engine is configured to wirelessly connect the mobile electronic device to at least one computer system via at least one of a telnet, a ssh, a http, and a https.
